(19) United States
(12) Patent Application Publication
(10) Pub. No.: US 2019/0039616 A1
(43) Pub. Date: Feb. 7, 2019

(54) APPARATUS AND METHOD FOR AN AUTONOMOUS VEHICLE TO FOLLOW AN OBJECT

(71) Applicant: Ford Global Technologies, LLC, Dearborn, MI (US)

(72) Inventors: Jonatan LEFF YAFFE, Mexico City (MX); Francisco Javier QUINTERO PEREZ, Michoacan (MX); Ricardo RAMOS VALENCIA, Mexico (MX)

(21) Appl. No.: 16/076,464

(22) PCT Filed: Feb. 9, 2016
(86) PCT No.: PCT/US2016/017115

§ 371 Date: Aug. 8, 2018

(51) Int. Cl. B60W 30/16; G08G 1/00; G05D 1/00; H04W 4/02; H04W 4/029; H04W 4/024; H04W 4/44; H04W 4/38

(52) U.S. Cl. CPC B60W 30/16; G08G 1/22; G05D 1/0088; H04W 4/023; G01S 13/931; H04W 4/024; H04W 4/44; H04W 4/38; G05D 2201/0213; H04W 4/029

(57) ABSTRACT

A vehicle processor, in response to a follow request from a mobile device, senses a location of an object associated with the mobile device relative to the vehicle and execute a series of autonomous drive commands based on the relative location such that the vehicle tracks movements of the object to follow the object along a route traveled by the object.

### TECHNICAL FIELD

The present invention relates to various modes, options, and settings associated with an autonomous vehicle.

### BACKGROUND

Autonomous vehicles are capable of sensing their surrounding environment and navigating without any human interaction. Autonomous vehicles accomplish this through a variety of vehicle technology.

### SUMMARY

A first illustrative embodiment describes a vehicle processor that, in response to a follow request from a mobile device, senses a location of an object associated with the mobile device relative to the vehicle and executes a series of autonomous drive commands based on the relative location such that the vehicle tracks movements of the object to follow the object along a route traveled by the object.

A second illustrative embodiment describes an autonomous vehicle comprising a wireless transceiver configured to exchange data with a mobile device of a user, a sensor configured to output pulses to an object associated with the user, and a controller configured to activate a follower mode setting of the vehicle to enable the vehicle to automatically follow the object by executing a series of autonomous drive commands that are based on the data and feedback from the pulses.

A third illustrative embodiment describes a method implemented in an autonomous vehicle comprising, in response to receiving an activation signal from a mobile device associated with a user, activating by a controller a follower mode setting configured to enable the vehicle to drive autonomously, transmitting by a sensor pulses to an object associated with the user, and executing a series of autonomous drive commands that are based on feedback from the pulses such that the vehicle follows the object.

### BRIEF DESCRIPTION OF THE DRAWINGS

FIG. 1 is an exemplary embodiment of an autonomous driving control coupled to various vehicle modules.

FIG. 2 is an illustrative embodiment of the autonomous vehicle following or trailing a pedestrian and/or object.

FIG. 3 is an illustrative flow chart of the autonomous vehicle system's operation for following an object/pedestrian.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

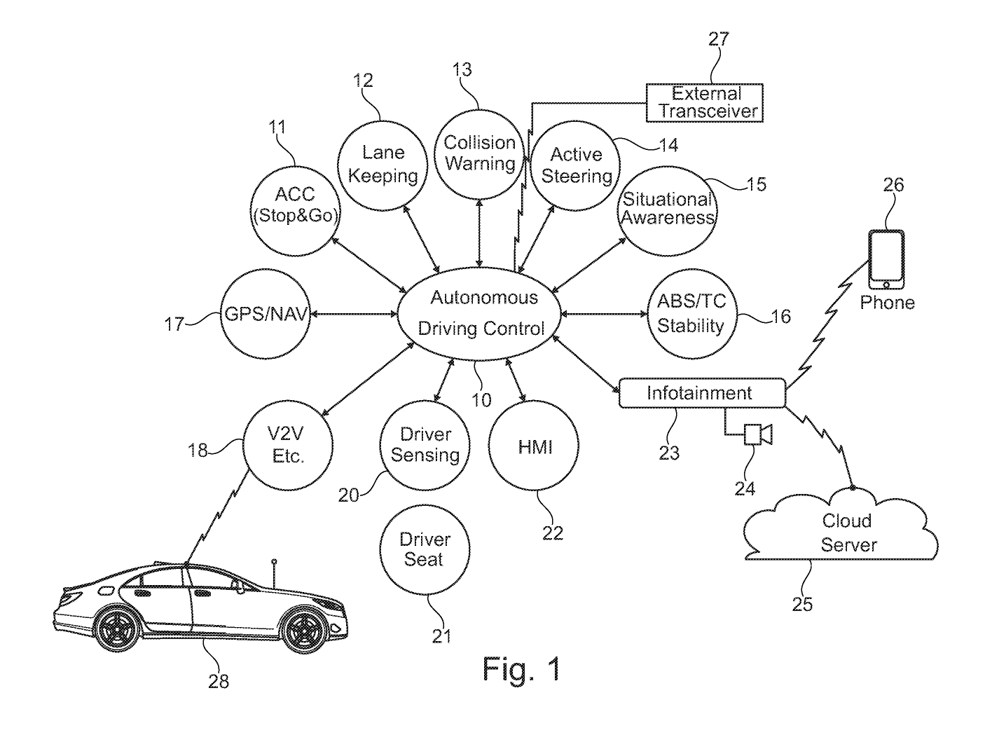

Referring to FIG. 1, an autonomous driving control 10 is coupled to various systems and subsystems to obtain autonomous vehicle functioning. An adaptive cruise control (ACC) module 11 may provide a “stop and go” function capable of controlling vehicle forward movement in response to both a leading object and traffic control devices such as stop signs and traffic lights. ACC module 11 is coupled to an engine or powertrain control unit (not shown) for accelerating and decelerating the vehicle. A lane keeping module 12 may preferably include the functionality of a lane departure warning system and/or a lane-keeping assistance system. A collision warning system 13 may preferably include forward, side, and rearward looking radar sensors and/or cameras providing data to an object identification system and tracking system. Collision warning system 13 may work together with other remote sensing components in a situational awareness block 15 to identify fixed or moving obstacles or other hazards.

An active steering subsystem 14 responds to commands from autonomous driving control 10 for changing a vehicle heading (e.g., to make turns or to follow a desired lane). Slowing or stopping of the vehicle is provided by a braking system 16 which may include ABS and/or stability control subsystems. The vehicle may utilize an automatic transmission (if appropriate) to handle shifting between gears when approaching different speeds. The autonomous vehicle driving control 10 may also be coupled to sensors utilized to detect objects surrounding the vehicle.

A GPS and navigation unit 17 is coupled to autonomous driving control 10 for providing vehicle position, speed, and heading information. A map database is stored within GPS unit 17 or is remotely accessed by GPS unit 17 (e.g., over a wireless data connection) for route planning and monitoring. The map database may include data pertaining to ADAS (advanced driver assistance system) to help the autonomous vehicle navigate. Such ADAS map data may include advanced lane information (e.g. lane count, lane width), road descent information, and other advanced map data. Other remote information can be accessed wirelessly using a vehicle-to-vehicle (V2V) system 18 or by connecting to an off-board server 25 (e.g. “the cloud”), for example. A V2V system 18 allows the information to be communicated to other vehicles 28 wirelessly to facilitate autonomous driving. Such information may include vehicle travel data (e.g. speed, direction, maneuvers, etc.). The off-board server 25 may be utilized to send dynamic information, such as traffic, weather, local events, etc.

To provide the driver monitoring, a driver sensing block 20 is coupled to autonomous driving control 10. Driver sensing block 20 includes one or more sensors directed to a driver seat 21 for detecting the presence or absence of the driver in a proper seated position in driver seat 21 and the physiological state of the driver. The vehicle may determine who the driver is based on the settings of the seat, a specific setting selected for the seat, or by detecting a specific key fob or cell phone 26 of the driver.

A human-machine interface (HMI) 22 may be in communication with the autonomous driving control 10. The HMI 22 may include push buttons, dials, voice activated systems, or other inputs to obtain driver input (e.g., when specifying a trip destination and/or route). Additionally, the HMI 22 may include a graphic display to provide driver feedback. Driver feedback may also be provided using a vehicle computer system 23 (such as a Ford SYNC® system) to generate audible warning messages over an audible speaker 24. The vehicle computer system 23 may also be in communication with mobile devices 26 to communicate data or other information from a mobile device 26. Furthermore, the vehicle computer system 23 may be used to facilitate communication to off-board servers through the use of an embedded telematics system or by utilizing a mobile device (e.g. cell phone).

The autonomous vehicle may be equipped with an external transceiver 27 to communicate with other devices or objects. The external transceiver 27 may be utilized to send radar pulses to determine a distance to an object or the relative speed of another object, similar to the technology utilized in collision warning system 13 and advanced cruise control system 12. Furthermore, the external transceiver 27 may contain both short-range (WI-FI, Bluetooth, etc.) and long-range (3G, 4G, or LTE cellular connection) transceivers to communicate data with other devices.

The autonomous vehicle may include, but not be limited to the following features: object detection, adaptive cruise control (ACC), adaptive high beam, glare-free high beam and pixel light, adaptive light control, swiveling curve lights, automatic parking, automotive navigation system with off-board traffic information, automotive night vision, blind spot monitor, collision avoidance system (Precrash system), crosswind stabilization, driver drowsiness detection, driver monitoring system, electric vehicle warning sounds used in hybrids and plug-in electric vehicles, emergency driver assistant, forward Collision Warning, Intersection assistant, Hill descent control, Intelligent speed adaptation or intelligent speed advice (ISA), Lane departure warning system, Lane change assistance, Pedestrian protection system, Traffic sign recognition, Turning assistant, Vehicular communication systems, Wrong-way driving warning, etc.

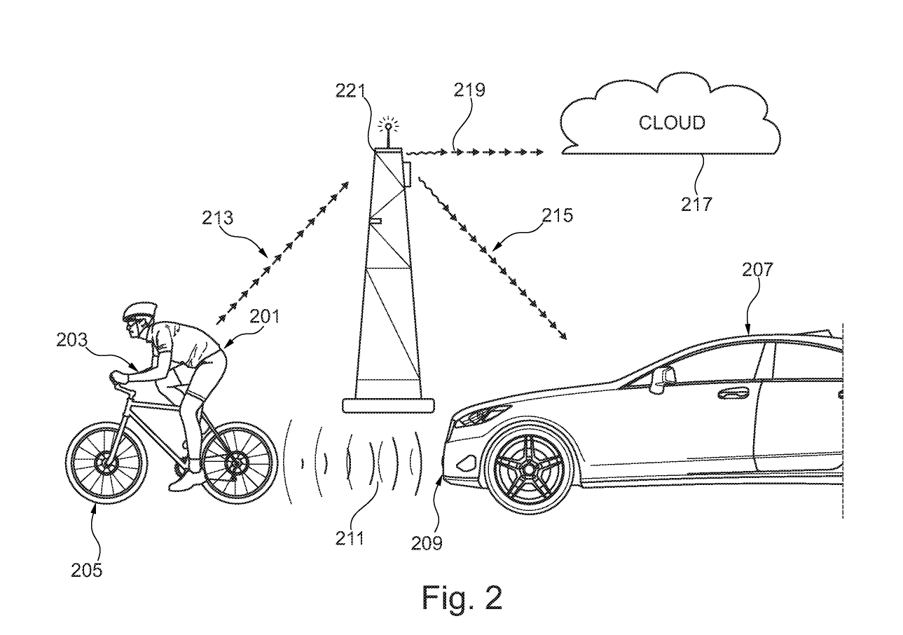

FIG. 2 is an illustrative embodiment of the autonomous vehicle following or trailing the pedestrian. The autonomous vehicle 207 may be configured by one or more settings to follow a pedestrian 201. For example, the pedestrian 201 may set a determined distance (e.g. 50 ft., 100 ft., 200 ft., etc.) that the autonomous vehicle should trail the pedestrian 201. The distance may be set within the vehicle HMI or by utilizing a mobile device (e.g. phone, tablet, wearable device, etc.) that includes an interface to work with the vehicle. Furthermore, the vehicle 207 may follow an object 205 associated with the pedestrian 201. The system may actively determine a minimum safe distance to the user based on speed and road conditions, which may override a user's setup if it is below such a minimum distance.

An automated-follower system of the vehicle may provide a sense of security and protection from a user's vehicle that may be located behind them when traveling. The Follower System may be able to leverage various vehicle mobility technology, combined with computer vision and differential GPS technology to track the user. The vehicle may track the user's position, distance and speed thru utilizing a mobile device, such as an integrated key fob or an armband or bicycle attached component. The mobile device itself may not be initially configured to interact with the vehicle, however, a user may download an application or install software on the mobile device to integrate with a follower system of the vehicle. The vehicle may utilize additional sensors for vehicle navigation, including adaptive cruise control, active city stop alerts, lane keeping sensors, and car approaching sensors. The sensor data may be used to follow the user at a safe distance.

The pedestrian 201 may be on a bicycle 205 or another means of transportation when utilizing the automated follower system. The pedestrian 201 may wear a mobile device 203 to facilitate the autonomous driving. The mobile device may send directions, routes, or way points to the user. In another embodiment, the mobile device 203 may emit a wireless signal that allows the connected vehicle to communicate with the device. The vehicle 207 may send data to mobile device 203 and request a response. By determining the timing of reception of the response from the mobile device 203, the vehicle 207 may estimate the distance that the mobile device 203. Furthermore, the communicated data between the vehicle 207 and the mobile device 203 may include other information to determine the distance between the vehicle 207 and the mobile device 203. Such information may include GPS coordinates, a time stamp, location information, request, a pre-defined route, etc.

While the mobile device 203 may directly communicate with the vehicle 207 through the use of vehicle computer system or another module, the vehicle 207 may also communicate indirectly with the mobile device 203 and the pedestrian 201. The vehicle 207 may be equipped with a wireless transceiver that communicates signals 215 to a cellular tower 221. The cellular tower 221 may be used to facilitate communication to the mobile device 203 via communication signal 213. This will allow flexibility of communication in case of errors or failures with transceivers, modules, or any other type of system.

The vehicle 207 may also be equipped with an external transceiver 209 or sensor to communicate with the pedestrian 201, mobile device 203, or object associated with the pedestrian 205. The transceiver 209 may be programmed to emit pulses or signals 211 to communicate with the mobile device 203, pedestrian 201, or bicycle or other means of transportation 205. By being located on an external surface of the vehicle 207, the transceiver 209 may have a clear path for communicating signals 211 to the mobile device 203, pedestrian 201, or transportation means 205. The transceiver me be used to not only communicate data, but for emitting pulses or signals to and from the object to detect a distance or speed that the pedestrian 201 or transportation means 205 is traveling. Additionally, the mobile device 203 may send signals indicating a GPS location, route, or other location/direction information to assist with leveraging the autonomous vehicle 207 to follow the pedestrian 201 or transportation means 205. Additionally, while the external transceiver 209 may be located outside of the vehicle, other embodiments could have a similar transceiver located within the autonomous vehicle's cabin.

Both the vehicle 207 and mobile device 203 may be in communication with an off-board server 217 (e.g. “the cloud”) to facilitate in communication or to retrieve additional information. For example, the cloud 217 may be used to send information to facilitate with following the pedestrian 201 or bicycles pass. In one example, the cloud 217 may utilize traffic, weather, local event information, or other dynamic information to help facilitate travel to follow the pedestrian. The cloud 217 may be able to facilitate communication of dynamic information by sending communication signals 219 to the cellular tower 221. From there, the cellular tower 221 may send data to the vehicle via communication signals 215 or to the mobile device 203 via communication signals 213. The off-board data can then be used to facilitate the autonomous vehicle's following of the pedestrian 201.

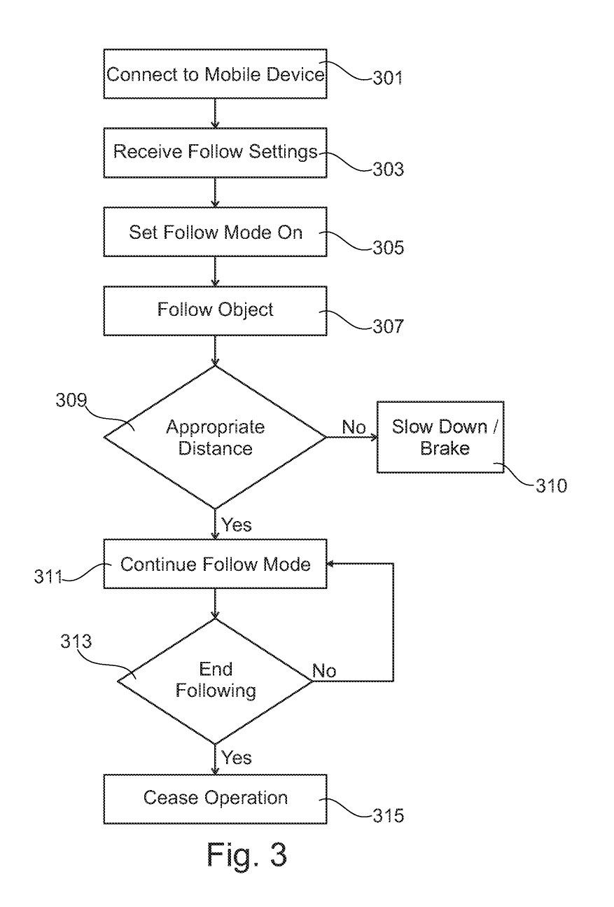

FIG. 3 is an illustrative flow chart of the autonomous vehicle system's operation upon following a pedestrian. While the embodiment below is described with respect to the vehicle computer system handling the operation, a mobile device may also be configured to handle the operation of the autonomous vehicle's follower system. For example, the mobile device may send and receive instructions and other data to the vehicle or off-board server to initiate and control the automated system of the vehicle.

The vehicle computer system may connect to a mobile device 301 via a wireless connection. The connection may be a direct connection via Bluetooth, radar, sonar, Wi-Fi, vehicle-to-vehicle communication, or any other similar short-range communication system. In other embodiments, the mobile device 301 and vehicle computer system may communicate indirectly amongst one another by utilizing an off-board server or “the cloud” to communicate data. For example, the mobile device may have long-range cellular connection (e.g. LTE, 3G, etc) or other type of connection (e.g. Wi-Fi) that communicates with a server. The off-board server may then communicate information and data from the mobile device to the vehicle computer system based on a connection between the vehicle computer system and the server. Data may be communicated back-and-forth between the vehicle computer system and the mobile device, or vice versa. The wireless communication may be accomplished by utilizing the vehicle's computer system or by utilizing a specialized external transceiver located on the front of the vehicle.

The mobile device or the vehicle computer system may include various options for a “follow mode.” At a high-level, the follow mode will allow the autonomous vehicle to follow a pedestrian, specific device, or object. The follow mode may include a variety of options or settings associate with the autonomous vehicle upon utilizing the follow mode. Such options may include a setting to set a max/min speed of the vehicle when in follow mode, a specific distance, duration, and other options. The settings may be set on the autonomous vehicle (e.g. user interface, vehicle computer system, voice recognition, etc.) or the mobile device. Once communication has been established with the autonomous vehicle and the mobile device, the vehicle computer system may receive the setting and associated options for follow mode 303. For example, the mobile device may send a message to the autonomous vehicle initiating activation of the follow mode. Upon sending a message activating the follow mode, a message may be sent simultaneously, or afterwards, indicating which options or settings should be set (e.g. follow distance, speed, etc.).

Furthermore, the system may include various preset settings to quickly configure the vehicle for utilizing the automated follower system. For example, there may be preset modes to follow a runner versus a cyclist. Additionally, the user may be able to set a custom preset feature. Such presets may specify various characteristics to optimize the vehicle's following of the object.

The autonomous vehicle may then set the follow mode setting on, including activation of the associated options 305. Upon setting the follow mode option on, various modules and controllers of the vehicle (e.g. Advanced Driver Assisted Systems or ADAS) may prepare to enter into the follow mode. For example, if the intelligent cruise control system, or other ADAS feature, was not previously activated, it may be activated upon entering the follow mode. Upon follow mode being activated, the autonomous vehicle may receive additional data from the mobile device to help prepare the vehicle to follow the pedestrian. The mobile device may send coordinates of its current GPS location, or may send the vehicle a planned route that the user may take. Furthermore, the mobile device may simply send messages back and forth directly to the vehicle to calculate the distance the mobile device is from the vehicle.

The autonomous vehicle may then begin operation by following the object and/or mobile device 307. The autonomous vehicle may begin to follow an object, such as a cyclist or pedestrian, utilizing the mobile device once the operation has begun. In certain embodiments, the vehicle may utilize various ADAS features to detect an object associated with the mobile device. For example, cameras, radar, or LiDAR may be utilized to determine that the mobile device is a specific distance from the vehicle, and that a certain object is associated with the mobile device. The autonomous vehicle may recognize that the associated object should be followed, as it may be the primary target for the autonomous vehicle to follow. The vehicle will keep a specified distance from the object based on the setting. The vehicle may utilize various pulses or signals emitted from a radar, sonar, camera, or LIDAR, in conjunction with ADAS features, to facilitate in following an object. For example, the LiDAR determines distance to an object by measuring the time delay of a laser pulse that is transmitted to an object and reflected back from the object. The direction is determined based on the direction that the LiDAR is pointed when transmitting and/or receiving the laser pulse. Radar may send a radar pulse to the object, and receive a reflected pulse to determine the distance and direction of an object.

The autonomous vehicle's system may then monitor the follow mode to make sure all correct options are set within the vehicle. For example, the system may be constantly monitoring the objects distance to make sure that the appropriate distance is met 309. If the distance is sufficient, then the system will continue to monitor the distance and continue operation in follow mode 311. If the distance is too close to the object, the vehicle may slow down or brake to a complete stop 310. The autonomous vehicle's operation may also be overridden based on a signal sent from the mobile device or off-board server.

The system may then also determine if it is appropriate to stop the autonomous system 313. Certain conditions that may trigger a stop include completing the user's route, emergency event or situation, vehicle component failure, or an emergency shut-off initiated by a user. Upon any such situations, the following mode may cease operation 315. For example, if the autonomous vehicle senses that an accident may occur with another vehicle or object, the autonomous vehicle may cancel the follower mode option and send a message to the mobile device of the user indicating the cancelation. In another example, the autonomous vehicle may utilize GPS data and a navigation map database to determine that the user, transportation means, and mobile device have gone off-road for a conventional vehicle. Thus, while the object may be moving, the vehicle will realize that it needs to stop following the object and send a message to the mobile device indicating that the follow mode has ceased operation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a processor configured to, in response to a follow request from a mobile device, sense a location of an object associated with the mobile device relative to the vehicle and execute a series of autonomous drive commands based on the relative location such that the vehicle tracks movements of the object to follow the object along a route traveled by the object.

2. The vehicle of claim 1, wherein the processor is further configured to follow the object in response to follow data communicated between the mobile device and the processor.

3. The vehicle of claim 2, wherein the follow data includes information related to a location of the mobile device.

4. The vehicle of claim 2, wherein the follow data includes a timestamp indicating a time the data is sent to the mobile device.

5. The vehicle of claim 2, wherein the follow data includes a timestamp indicating a time the data is received at the mobile device.

6. The vehicle of claim 2, wherein the follow data includes a pre-defined route for the object and wherein the processor is further configured to execute the series of autonomous drive commands based on the pre-defined route.

7. The vehicle of claim 1, wherein the processor is further configured to execute another series of autonomous drive commands to slow the vehicle based on a distance between the vehicle and the object being less than a default distance.

8. The vehicle of claim 1, wherein the processor is further configured to execute another series of autonomous drive commands to stop the vehicle based on an indication of an emergency event at or near the vehicle.

9. The vehicle of claim 1, wherein the processor is further configured to execute the series of autonomous drive commands based on the relative location such that the vehicle tracks the movements to follow the object along the route at a pre-defined distance defined by a user setting.

10. The vehicle of claim 1, wherein the mobile device is configured to be worn by a user.

11. The vehicle of claim 1, wherein the mobile device is a key fob, cellular phone, smart watch, or wearable device.

12. An autonomous vehicle comprising:
a wireless transceiver configured to exchange data with a mobile device of a user;
a sensor configured to output pulses to an object associated with the user; and
a controller configured to activate a follower mode setting of the vehicle to enable the vehicle to automatically follow the object by executing a series of autonomous drive commands that are based on the data and feedback from the pulses.

13. The autonomous vehicle of claim 12, wherein the data defines a user-selected pre-defined distance at which the vehicle is to follow the object.

14. The autonomous vehicle of claim 12, wherein the data includes a request from the mobile device to activate the follower mode setting.

15. A method implemented in an autonomous vehicle comprising:
in response to receiving an activation signal from a mobile device associated with a user, activating by a controller a follower mode setting configured to enable the vehicle to drive autonomously;
transmitting by a sensor pulses to an object associated with the user; and
executing a series of autonomous drive commands that are based on feedback from the pulses such that the vehicle follows the object.

16. The method of claim 15, wherein the follower mode setting defines a pre-defined distance such that the vehicle follows the object at the pre-defined distance.

17. The method of claim 16 further comprising receiving a pre-defined route for the object from the mobile device, and wherein the executing is further based on the route.
